(19) United States
(12) Patent Application Publication
(10) Pub. No.: US 2005/0086389 A1
(43) Pub. Date: Apr. 21, 2005

(54) Wireless network adapter

(76) Inventor: Phillip Chang, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/686,604

(22) Filed: Oct. 17, 2003

(51) Int. Cl. G06F 15/16

(52) U.S. Cl. 709/250

(57) ABSTRACT

A self-powered wireless network adapter device that provides convenient wireless access to a wired network environment by simply plugging the device into a network port. The device is a networking device that offers users a method to eliminate messy wiring when connecting to a network on the road. Once the device is inserted into the port, the user can immediately access the network with their wireless device and transfer files, access email, or browse the Internet. Rechargeable batteries allow the device to be self-powered and recharged. A universal serial bus connector is provided for recharging the device via a USB port. The invention further provides wireless communication capabilities via the USB connector for devices without wireless communication abilities by plugging the invention into the device's USB port. The invention not only provides wireless access to wired networks, but also allows non-wireless electronic devices to become capable of wireless communication.

### BACKGROUND OF THE INVENTION

1. Field of the Invention

The present invention relates to wireless communications. More specifically, the present invention discloses a self-powered wireless network adapter device that provides convenient wireless access to a wired network environment by simply plugging the device into a regular RJ-45 port.

2. Description of the Prior Art

With the increasing popularity of wireless enabled devices and the incorporation of wireless technology into products such as Intel Corp. Centrino based notebook computers, users have grown attached to their wireless connectivity.

However, the luxury of wireless connectivity isn't always available to mobile users on the road. Hot spots can offer wireless connection, but are limited to a few certain areas. These hot spots usually are found in locations such as restaurants that require a user to purchase something in order to access the internet. This adds to the expense for users of the network. Furthermore, these locations are usually noisy and not conducive to productivity.

Additionally, conventional methods for upgrading a standard wired network to a wireless network are expensive. Therefore, only a few corporations have chosen to invest in the upgrade. As a result, mobile users cannot enjoy the convenience of wireless connectivity wherever they want it.

Therefore, there is a need for a low cost and efficient self-powered wireless network dongle or adapter device that provides convenient wireless access to a wired network environment by simply plugging the device into a regular RJ-45 port.

### SUMMARY OF THE INVENTION

To achieve these and other advantages and in order to overcome the disadvantages of the conventional method in accordance with the purpose of the invention as embodied and broadly described herein, the present invention provides a self-powered wireless network dongle or adapter device that provides convenient wireless access to a wired network environment by simply plugging the device into a regular RJ-45 port.

The device of the present invention is a networking device that offers users a method to eliminate messy wiring when connecting to a network or local area network (LAN) connection on the road. The device can simply be plugged into a standard network port such as an RJ-45 port. Once the device is inserted into the port, jack, or outlet, the user can immediately access the wired network with their wireless device. The device of the present invention allows a standard LAN to benefit from wireless connectivity such as IEEE 802.11 a/b/g.

For example, a user with a wireless compatible notebook computer travels to a client in a remote location. While preparing to give a presentation, the user notices they forgot to bring certain data. The user quickly plugs the wireless network adapter into an RJ-45 jack in the wall of the conference room. Immediately, the notebook computer's wireless fidelity (WiFi) system will detect the wireless network dongle's identification or ID, and the device will efficiently perform as a wireless to Ethernet bridge. The user now has wireless access to the client's network or the internet from their notebook and proceeds to transfer the needed data from their office computer.

Most network users recall the unsightly mess of conventional wiring and cabling for network access. A common occurrence in a typical office is when a user is connected to a network by a network cable and the cable is stretched from the computer on a conference table to the wall outlet. When other people enter the room, their access is obstructed by the cable, thus requiring them to move, move the computer, or disconnect the cable. This is inconvenient, unproductive, and lacks professionalism. Even more, if someone trips over the cable, they can be injured or the computer could be damaged or destroyed. Furthermore, when multiple users wish to use the network, multiple cables are required which exacerbate the above-mentioned problems.

However, with the wireless network adapter of the present invention, this situation does not exist. Users can conveniently access the network and people can freely move around the room without tripping over cables. Additionally, the wireless network dongle of the present invention can be set up so that multiple users can use one network dongle.

Since the wireless network dongle or wireless network adapter of the present invention is very small, a user can easily carry the device with them wherever they go. The device is extremely portable as it is only about the size of a standard cigarette lighter, making it more convenient than carrying network cables or access points.

Additionally, the device is self-powered. This provides further convenience as an external power supply or power source is not required. The device comprises rechargeable batteries and a universal serial bus (USB) connector is provided for recharging the batteries via a USB port. Recharging occurs when the device is plugged into an available USB port.

The USB connector further provides wireless communication capabilities for devices without wireless communication abilities. For example, a notebook computer without WiFi can be made wireless by plugging the device into the notebook's USB port. This allows the device not only to provide wireless access to wired networks, but also allows non-wireless electronic devices to become wireless devices. Therefore, even if users do not a device equipted with wireless communication capabilities, they can enjoy the benefits of wireless connectivity by utilizing the device of the present invention. Moreover, using two devices of the present invention, a non-wireless device can wirelessly connect to a wired network. The user simply plugs one device into the network port of the wired network and another device into the USB port on their non-wireless computer.

Furthermore, the coverage area can be selectively reduced to a small personal area. This provides better security over conventional methods which have a large broadcast area. The reduced coverage area also eliminates potential interference or crosstalk problems so that multiple users can use multiple devices in a common area.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram illustrating a wireless network adapter according to an embodiment of the present invention;

FIG. 2 is a drawing illustrating the external characteristics of the wireless network adapter according to an embodiment of the present invention; and

FIG. 3 is a drawing illustrating the external characteristics of the wireless network adapter according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

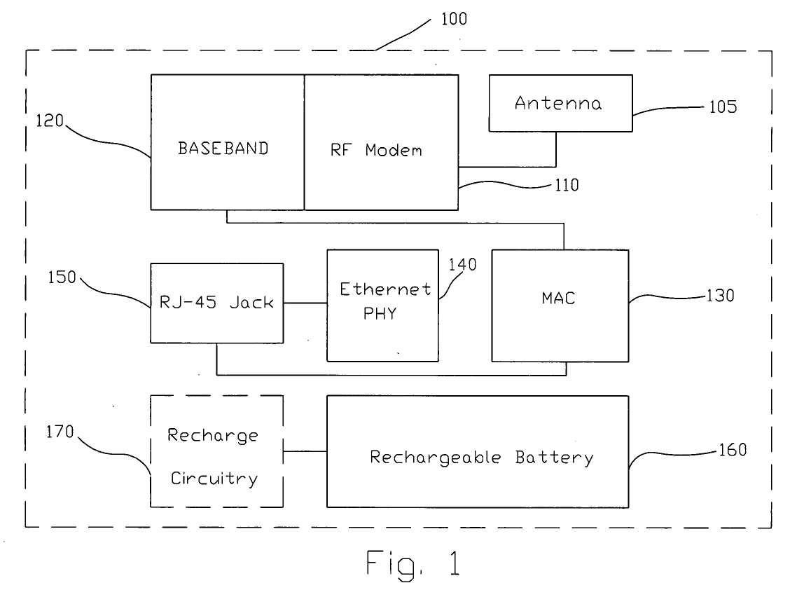

Refer to FIG. 1, which is a block diagram illustrating a wireless network adapter according to an embodiment of the present invention.

The wireless network adapter 100 comprises a radio frequency (RF) modem 110, an antenna 105, a baseband 120, a media access control (MAC), an Ethernet physical layer 140, an RJ-45 port 150, a rechargeable batter 160, and recharge circuitry 170.

The antenna 105 is either an internal antenna or an external antenna. The antenna 105 further comprises a sensitivity gain control for selecting the sensitivity. For example if the computer connecting to the network is close to the adapter, the sensitivity can be set low. This provides increased security for the user. Alternatively, if the computer is located far from the adapter, the sensitivity can be set to high.

The RF modem 110 via the antenna 105 provides data transfer capabilities for the device. Data from the connecting computer is received by the RF modem 110 and data to the connecting computer is transmitted by the RF modem 110.

The baseband 120 provides a system in which information is carried on a signal channel. All data coming into or going out of the wireless network adapter is carried on the baseband 120.

The MAC 130 provides access control to the network for the connecting computer. In other words, the MAC regulates traffic between the connecting computer and the network. On a LAN, a MAC address is provided for identifying a computer. The MAC address is a unique hardware number. When a computer tries to connect to the network, the MAC 130 provides a table relating the Internet Protocol (IP) address to the MAC address on the LAN. The MAC address is used by the MAC layer of the data link layer of telecommunication protocol. The MAC 130 thereby ensures that data transmission is transmitted to and received from the correct computer. One or more MACs are provided for regulating traffic. In embodiments of the present invention whereby multiple users wish to share the device of the present invention, a plurality of MACs are provided.

The Ethernet layer 140 is provided as a method of physical communication in a LAN. In order for the connecting computer to communicate with the network or LAN, the Ethernet layer 140 is required to ensure correct communication protocol to the network. Since the connecting computer utilizes wireless communication protocol to transmit and receive data and the network utilizes Ethernet protocol, the device of the present invention provides a means for translating between these protocols. In this way, the network and the connecting computer continue to utilize their standard protocols and the device of the present invention acts as a bridge between the two protocols. Utilizing the wireless network adapter of the present invention allows devices to access the network or LAN without any modification to the network or the connecting devices.

A battery is provided for supplying power to the device and its components. In an embodiment of the present invention the battery is a rechargeable battery 160. Recharge circuitry 170 is provided for recharging the rechargeable battery 160. Since the battery is rechargeable, the cost for replacing batteries is eliminated.

In another embodiment of the present invention, the battery is a standard dry cell battery such as an AA or AAA battery. Alternatively, the battery is a lithium ion battery commonly used in watches, mobile phones, or other portable electronic devices. The advantage of the standard dry cell battery is availability. A battery of this type can easily be located if needed. The advantage of the lithium battery is small size. In embodiments of the present invention, a plurality of batteries is provided.

In situations where available, the device of the present invention draws power directly from the network connection.

In order to recharge the rechargeable battery, a recharge adapter is provided. The recharge adapter is, for example, an alternating current (AC) plug or a universal serial bus (USB) connector. If an AC plug is provided, the device can simply be plugged into a standard AC outlet for recharging. In this embodiment, a transformer is provided for converting the alternating current to direct current. The AC plug and transformer can be attached to the device or in a separate cord. If a USB connector is provided, the device is plugged into a USB port on a computer for recharging. An advantage to using the USB connector for recharging is the device can be plugged into the USB port of the computer when not in use.

The USB connector also provides connection to a USB port on a non-wireless electronic device. Once the network adapter is plugged into an available USB port on the non-wireless device, the non-wireless device becomes capable of wireless communication. This increases the advantages of the present invention by not only providing wireless access to wired networks, but also provides wireless communication capabilities to non-wireless electronic devices.

In an embodiment of the present invention, the device further comprises flash memory and associated firmware. In this embodiment, when the device is connected to the USB port of the computer, not only is battery recharging performed, but the flash memory of the device provides a memory storage device. When the device is connected to the USB port of the computer, the computer automatically recognizes the device as a flash memory storage device and a user can access or store data in the flash memory of the device.

An RJ-45 port is provided for physically connecting the device to the network port. A LAN typically has standard RJ-45 connections placed throughout a building. In the conventional method, a user connects a cable between the computer and the RJ-45 outlet in the wall. With the present invention, a user simply plugs the RJ-45 connector 150 of the device 100 into the existing RJ-45 outlet of the building.

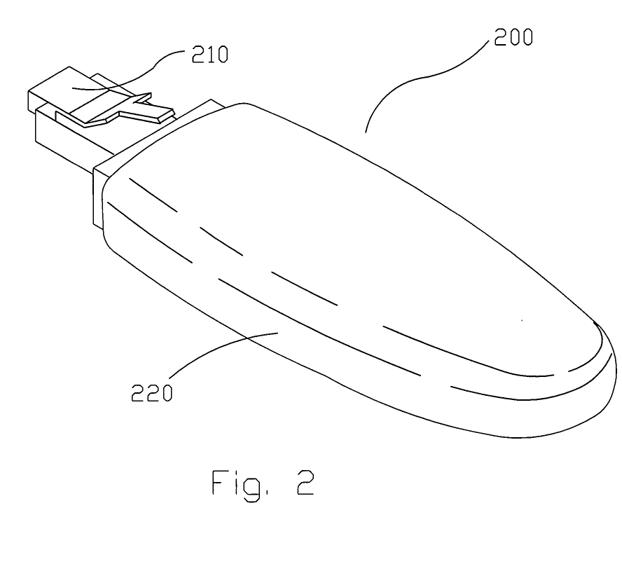

Refer to FIG. 2, which is a drawing illustrating the external characteristics of the wireless network adapter according to an embodiment of the present invention.

As shown in FIG. 2, the wireless network adapter 200 of the present invention comprises a housing 220 and an RJ-45 connector 210. The housing 220 is, for example, a plastic clamshell housing. All components described above are enclosed in the housing 220 with the RJ-45 connector 210 protruding from one end of the device 200.

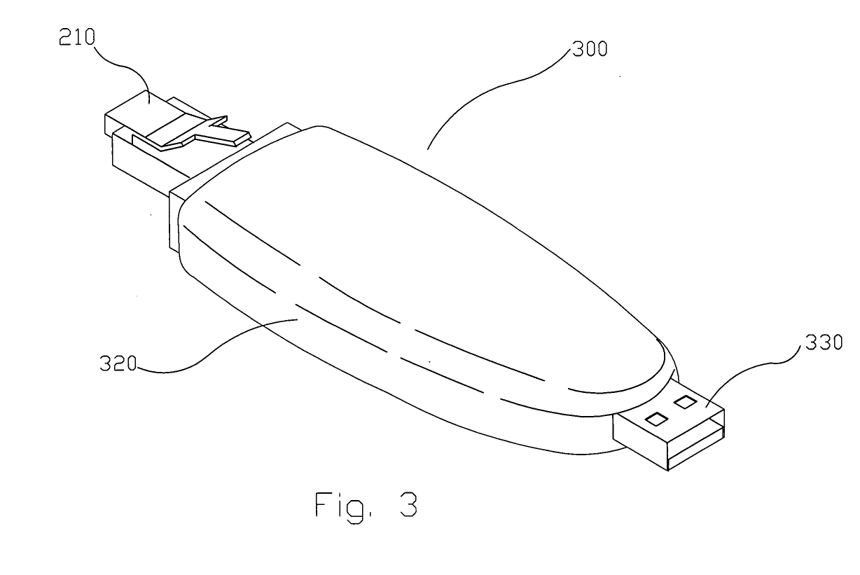

Refer to FIG. 3, which is a drawing illustrating the external characteristics of the wireless network adapter according to an embodiment of the present invention.

The embodiment illustrated in FIG. 3 is similar to the one in FIG. 2. The device 300 comprises a housing 320, an RJ-45 connector 310, and a USB connector 330. All components are enclosed in the housing 320 with the RJ-45 connector 310 and the USB connector 330 protruding from opposite ends of the device 300.

As can be easily seen in FIGS. 2 and 3, an advantage of the wireless network adapter of the present invention is its compact size. The device is approximately the size of a standard lighter. Due to the compact nature, the device can easily be carried in a pocket.

Therefore, the present invention provides a self-powered wireless network adapter device that provides convenient wireless access to a wired network environment by simply plugging the device into a regular RJ-45 port.

The device of the present invention is a networking device that offers users a method to eliminate messy wiring when connecting to a network or local area network (LAN) connection on the road. The device can simply be plugged into a standard network port such as an RJ-45 port. Once the device is inserted into the port, jack, or outlet, the user can immediately access the wired network with their wireless device.

When the device is plugged into the network port, the notebook computer's wireless fidelity (WiFi) system will immediately detect the wireless network adapter's identification or ID, and the device will efficiently perform as a wireless to Ethernet bridge. The user now has wireless access to the network or the internet from their notebook and proceeds to transfer files, access email, or browse the internet or LAN.

As described above, the device of the present invention has numerous advantages.

For example, the device of the present invention eliminates the unsightly mess of conventional wiring and cabling for network access.

Furthermore, the wireless network adapter of the present invention can be set up so that multiple users can use one wireless network adapter.

Since the wireless network dongle or wireless network adapter of the present invention is very small, a user can easily carry the device with them wherever they go. The device is extremely portable as it is only about the size of a standard cigarette lighter, making it more convenient than carrying network cables or access points.

Additionally, the device is self-powered. This provides further convenience as an external power supply or power source is not required. Also, rechargeable batteries are provided for added convenience and reduced cost to the user.

Furthermore, the coverage area can be selectively reduced to a small personal area. This provides better security over conventional methods which have a large broadcast area. The reduced coverage area also eliminates potential interference or crosstalk problems so that multiple users can use multiple devices in a common area.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

1. A network adapter device for providing wireless connectivity to a network comprising:
an antenna;
a radio frequency modem for receiving data from a wireless device and for transmitting data to the wireless device via the antenna;
a baseband for providing a signal channel;
a media access control for regulating traffic between the device and the wireless device;
an Ethernet layer for communicating with the network; and
a network connector for physically connecting the device to a network port.

2. The network adapter device of claim 1, whereby the network connector is an RJ-45 connector.

3. The network adapter device of claim 1, further comprising a sensitivity gain for adjusting coverage area.

4. The network adapter device of claim 1, further comprising a battery for providing power to the device.

5. The network adapter device of claim 4, whereby the battery is a rechargeable battery.

6. The network adapter device of claim 5, further comprising recharge circuitry for recharging the rechargeable battery.

7. The network adapter device of claim 1, whereby the device draws power from the network.

8. The network adapter device of claim 1, further comprising a universal serial bus connector for recharging the rechargeable battery via a universal serial bus.

9. The network adapter device of claim 8, whereby the device provides wireless communication capabilities to a non-wireless compatible device when the universal serial bus connector is connected to a universal serial bus port of the non-wireless compatible device.

10. The network adapter device of claim 8, further comprising a flash memory for storing data; whereby the universal serial bus connector of the device is connected to a universal serial bus port on a computer and data is stored in or accessed from the flash memory by the computer.

11. The network adapter device of claim 1, whereby a plurality of media access controls are provided for regulating traffic between the device and multiple wireless devices.

12. A portable self-powered network adapter that allows wireless devices to connect to a wired network.

13. A network adapter device for providing wireless connectivity to a network comprising:
an antenna;
a radio frequency modem for receiving data from a wireless device and for transmitting data to the wireless device via the antenna;
a baseband for providing a signal channel;
a media access control for regulating traffic between the device and the wireless device;
a rechargeable battery for providing power to the device;
recharge circuitry for recharging the rechargeable battery;
an Ethernet layer for communicating with the network; and
an RJ-45 network connector for physically connecting the device to a network port.

14. The network adapter device of claim 13, further comprising a sensitivity gain for adjusting coverage area.

15. The network adapter device of claim 13, further comprising a universal serial bus connector for recharging the rechargeable battery via a universal serial bus.

16. The network adapter device of claim 15, whereby the device provides wireless communication capabilities to a non-wireless compatible device when the universal serial bus connector is connected to a universal serial bus port of the non-wireless compatible device.

17. The network adapter device of claim 15, further comprising a flash memory for storing data; whereby the universal serial bus connector of the device is connected to a universal serial bus port on a computer and data is stored in or accessed from the flash memory by the computer.

18. The network adapter device of claim 13, whereby a plurality of media access controls are provided for regulating traffic between the device and multiple wireless devices.

19. A network adapter device for providing wireless connectivity to a network comprising:
an antenna;
a modem for receiving data from a wireless device and for transmitting data to the wireless device via the antenna;
a media access control for regulating traffic between the device and the wireless device;
a power source for providing power to the device;
a communications protocol adapter for providing communication protocol compatibility between wireless devices and the network; and
a network connector for physically connecting the device to a network port.

20. The network adapter device of claim 19, whereby the network connector is an RJ-45 connector.

21. The network adapter device of claim 19, further comprising a sensitivity gain for adjusting coverage area.

22. The network adapter device of claim 19, whereby the power source is a rechargeable battery.

23. The network adapter device of claim 22, further comprising recharge circuitry for recharging the rechargeable battery.

24. The network adapter device of claim 19, whereby the device draws power from the network.

25. The network adapter device of claim 19, further comprising a universal serial bus connector for recharging the rechargeable battery via a universal serial bus.

26. The network adapter device of claim 25, whereby the device provides wireless communication capabilities to a non-wireless compatible device when the universal serial bus connector is connected to a universal serial bus port of the non-wireless compatible device.

27. The network adapter device of claim 25, further comprising a flash memory for storing data; whereby the universal serial bus connector of the device is connected to a universal serial bus port on a computer and data is stored in or accessed from the flash memory by the computer.

28. The network adapter device of claim 19, whereby a plurality of media access controls are provided for regulating traffic between the device and multiple wireless devices.
